(19) United States
(12) Patent Application Publication
(10) Pub. No.: US 2003/0015058 A1
(43) Pub. Date: Jan. 23, 2003

(54) Racing flywheel

(75) Inventor: Christopher A. Bell, Cuba, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Ace Manufacturing & Parts Company

(21) Appl. No.: 10/246,852

(22) Filed: Sep. 18, 2002

Related U.S. Application Data
(63) Continuation of application No. 09/670,625, filed on Sep. 27, 2000, now abandoned.

(51) Int. Cl. G05G 1/00; G05G 3/00

(52) U.S. Cl. 74/572

(57) ABSTRACT

A flywheel for racing vehicles which has an increased life. The flywheel has reduced weight but resists deflection at high rpm to avoid plastic deformation and fatigue. The flywheel is formed to have more material lying in planes perpendicular to the axis of rotation while maintaining dimensions demanded by racing criteria.

### BACKGROUND OF THE INVENTION

This invention relates generally to flywheels for vehicle engines and more particular to such a flywheel for a stock racing vehicle.

In a ordinary passenger vehicle such as a family sedan, the inertia of the flywheel on the crankshaft coming from the internal combustion engine smooths out the rotation of the crankshaft and stores energy for use in accelerating the car after stops. The mass of the flywheel is selected for optimizing energy storage for the size and power of the engine. In the family sedan, the engine (and flywheel) rarely operates at high rpm for any extended period of time. A passenger vehicle traveling at 80 miles per hour would run at no more than about 2,500 rpm. Moreover, the mass of the flywheel makes it very robust so that failure is not a problem.

In stock car racing, the rules require that the cars have flywheels, just as ordinary or “stock” vehicles. Moreover, it is required that the flywheel have the normal axial offset between the center of the flywheel and the ring gear in accordance with the common arrangement of these parts in the consumer vehicle. As a result, the flywheel does not lie entirely within a single plane. The flywheel is of considerably less importance in racing vehicles than in standard consumer vehicles because racing vehicles do not start and stop, but travel for very extended period of time at high speed. For example, a stock car may operate at 8,000-9,000 rpm for several hours to complete a race. The inertia of the flywheel becomes a hindrance because of the energy from the engine taken up to maintain rotation of the flywheel detracts from the speed of the car. Accordingly, efforts have been made to reduce the mass of the flywheel to reduce its inertia. However, reduction in the mass and the high operating speeds has led to problems with maintaining the integrity of the flywheels. The non-planar configuration of the flywheel in combination with the sustained high rpm results in considerable deflection during the course of a race. The deflection can cause plastic deformation of the flywheel and, because of speed changes, fatigue. Usually the flywheel in a stock car must be replaced after each race because it is bent or otherwise damaged.

### SUMMARY OF THE INVENTION

Among the several objects and features of the present invention may be noted the provision of a racing flywheel which is lightweight; the provision of such a flywheel that can be used for multiple races; the provision of such a flywheel which resists deflection and high rpm; and the provision of such a flywheel which is durable.

Generally, a racing flywheel for a racing vehicle of the present invention has reduced deflection at high revolution for increasing durability and life. The flywheel is generally circular in shape and has gear teeth formed on its exterior. The flywheel further comprises a inner portion adapted for mounting the flywheel on a crankshaft of the vehicle, an intermediate portion extending radially outward from the inner portion, and an outer portion extending radially outward from the intermediate portion. Gear teeth disposed at the radially outer periphery of the outer portion. The inner portion lies substantially in a first plane, and the outer portion lies substantially in a second plane located to one side of the first plane and substantially parallel to the first plane whereby the flywheel resists deflection at high revolution.

Other objects and features of the present invention will be in part apparent and in part pointed out hereinafter.

### BRIEF DESCRIPTION OF THE DRAWINGS

FIG. 1 is an elevation of a flywheel incorporated on a crankshaft in conjunction with a clutch assembly;

FIG. 2 is a top plan view of the flywheel;

FIG. 3 is a bottom plan view of the flywheel;

FIG. 4 is a fragmentary section taken in the plane including line 4-4 of FIG. 3; and

FIG. 5 is a section like FIG. 4, but showing a prior art configuration.

Corresponding reference characters indicate corresponding parts throughout the several views of the drawings.

### DETAILED DESCRIPTION OF THE PREFERRED EMBODIMENT

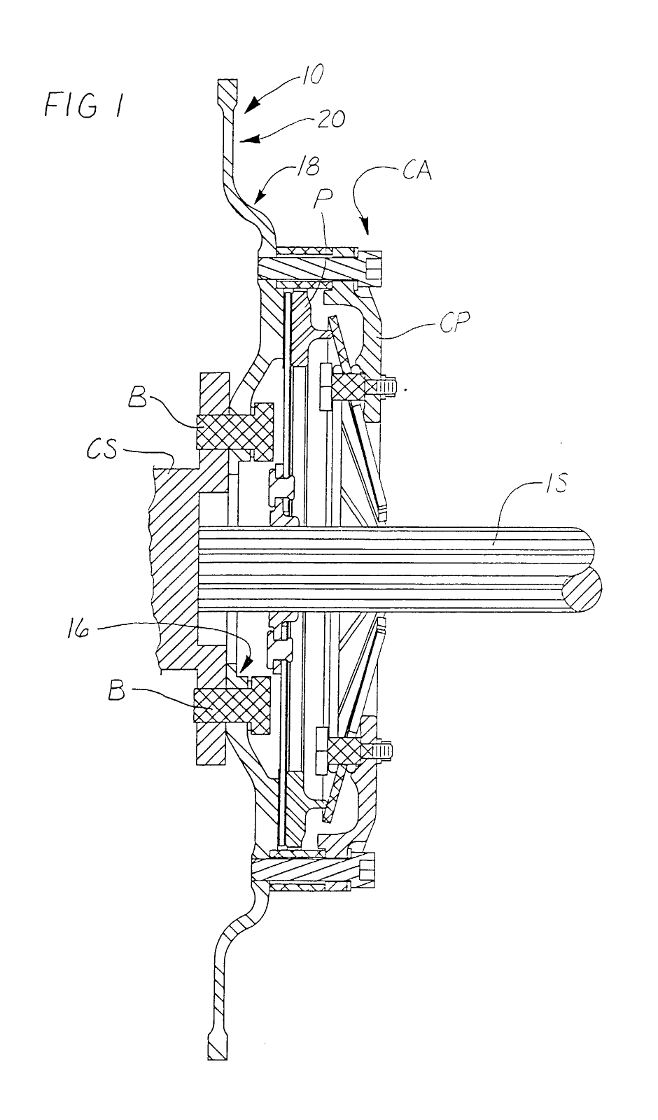

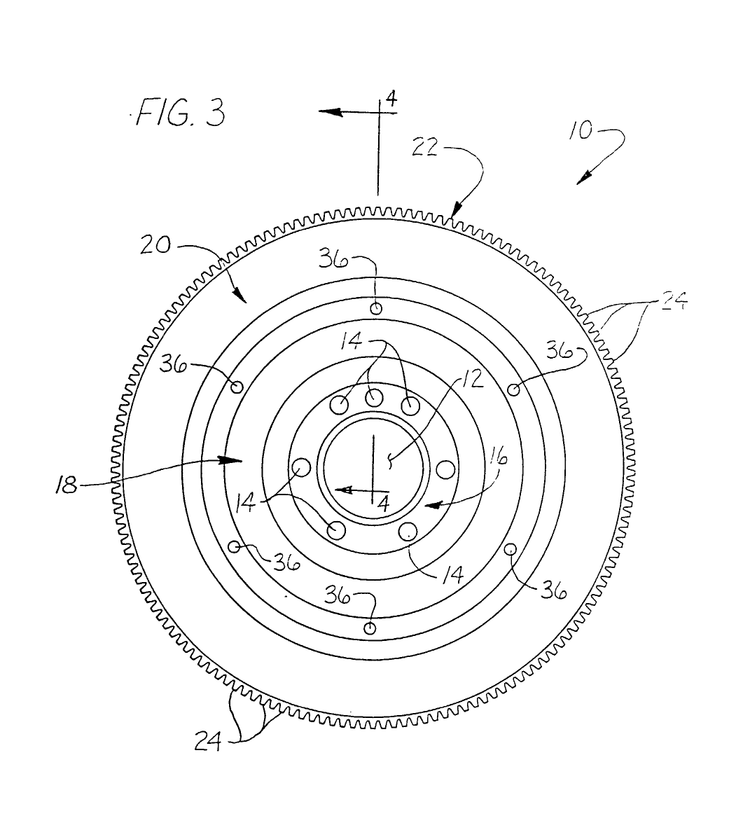

Referring now to the drawings and in particular FIGS. 1-3, a flywheel of the present invention (generally indicated at 10) is mounted on a crankshaft CR extending from an internal combustion engine (not shown) for conjoint rotation with the crankshaft. In the preferred embodiment, the flywheel 10 is incorporated into a racing vehicle (not shown), such as a stock car. The crankshaft CR is received in a central opening 12 of the flywheel 10. The attachment may be conventional, and is made by bolts B extending through openings in a flange F fixedly joined to the crankshaft CR and through holes 14 in an inner portion (generally indicated at 16) of the flywheel 10. A clutch assembly CA includes a cover plate CP mounted on the flywheel 10 for selectively interconnecting the flywheel and crankshaft CR with an input shaft IS for powering the racing vehicle. A disc D attached to the input shaft IS for conjoint rotation is engageable with the flywheel 10 and a pressure plate P of the clutch assembly CA for interconnecting the input shaft and flywheel. The clutch assembly CA can be a conventional racing clutch assembly, such as the clutch assembly disclosed in co-assigned U.S. Pat. No. 5,785,163, the disclosure of which is incorporated by reference. Accordingly, no further description of the clutch assembly will be made.

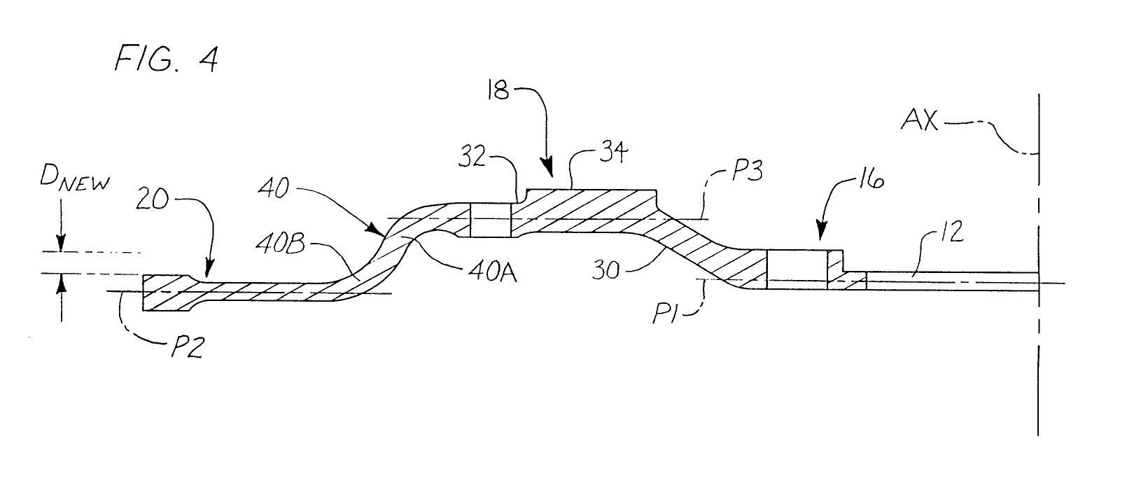

The flywheel 10 is generally circular in shape and is made of conventional material such as 4140 steel. The flywheel 10 has several generally annular portions including the inner portion 16 which includes the holes 14 for the bolts B which mount the flywheel on the crankshaft CR. An intermediate portion 18 extends radially outwardly from the inner portion 16, and an outer portion 20 extends radially outwardly from the intermediate portion to the periphery of the flywheel 10 were a ring gear 22 is located. The ring gear has teeth 24 disposed to mesh with the starter (not shown) for turning the flywheel 10 and crankshaft CR to start the engine. In a personal car and in a counterpart stock racing vehicle the axial location of the ring gear (relative to the axis of the crankshaft CR) is offset on the order of about 150 thousandths of an inch. This amount varies from vehicle to vehicle, but 0.150 inches is the amount of offset of the ring gear 22 from the inner portion 16 of the flywheel described herein. Referring to FIG. 4, the outer portion 20 lies in a second plane P2 axially located to one side of a first plane P1 of the inner portion 16. The ring gear 22 also lies in the second plane. Both the first and second planes P1, P2 are generally perpendicular to an axis of rotation AX of the crankshaft CR.

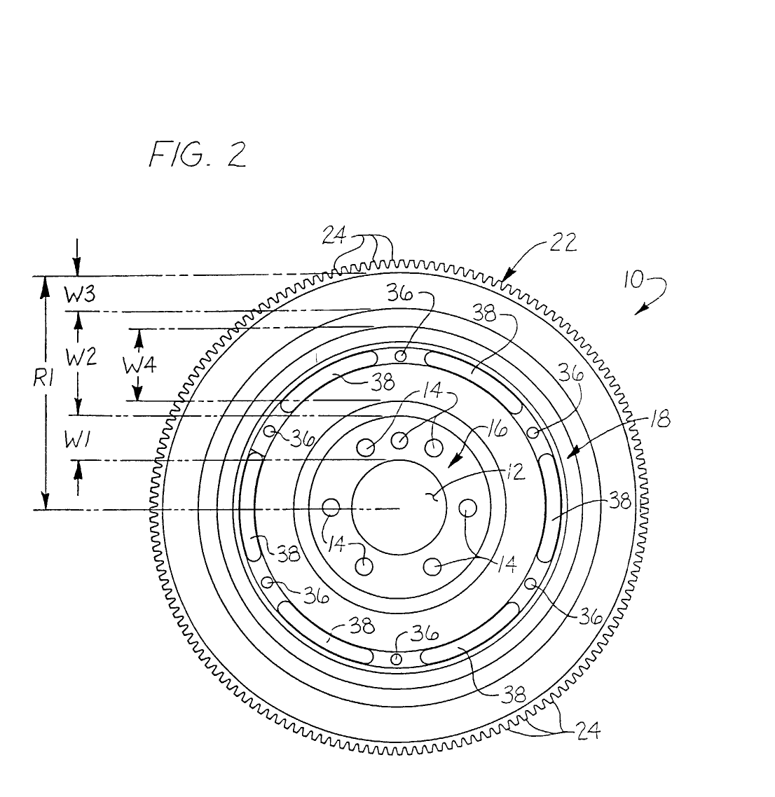

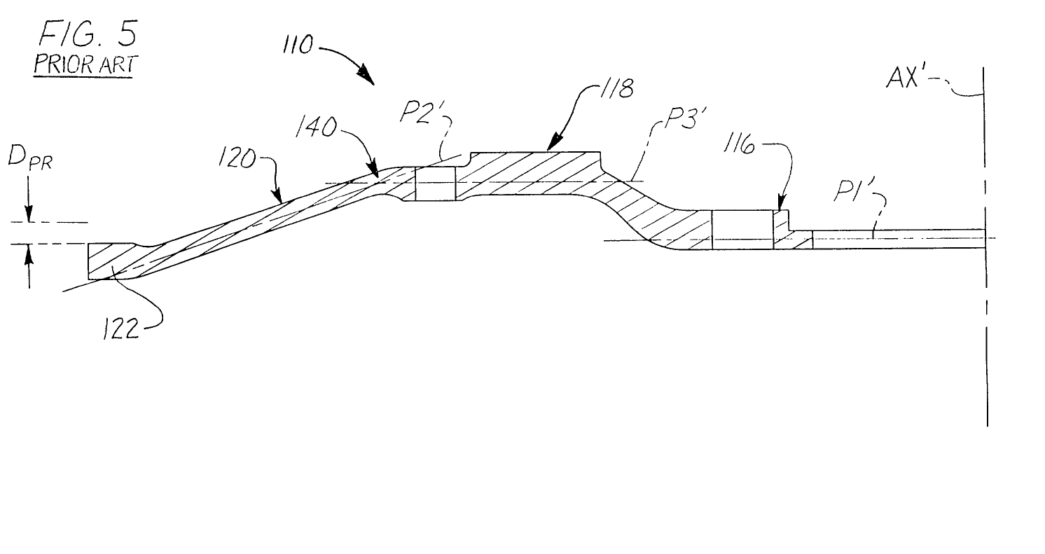

The intermediate portion 18 of the flywheel 10 extends axially to one side of a first plane P1 of the inner portion 16. A radially inner section 30 of the intermediate portion 18 extends axially (at an angle of about 150° to the first plane P1 of the inner portion 16) to a center section 32. The center section lies substantially in a third plane P3 perpendicular to the axis AX of the crankshaft CR and located on the opposite side of the first plane P1 of the inner portion 16 from the second plane P2 of the outer portion 20. The center section 32 of the intermediate portion 18 includes a flat annular frictional material platform 34 spaced farthest axially from the inner portion 16 and disposed for engaging (through a heat shield) the discs D of the clutch assembly CA for interconnection of the flywheel 10 with the input shaft IS. On a radius just outside the outer edge of the platform 34 are located apertures 36 for mounting the clutch cover plate CP on the flywheel 10 (FIG. 2). On the same radius, arcuate recesses 38 are formed in the flywheel 10 to further reduce the weight of the flywheel. The recesses 38 are about 0.05 inches deep in the illustrated embodiment. However, it is to be understood that the recesses 38 could be eliminated without departing from the scope of the present invention. Weight is also saved by making the outer portion 20 thinner than conventional. Again in the illustrated embodiment, the thickness of the outer portion is about 0.125 inches, whereas the prior flywheels (e.g., as shown in FIG. 5) are about 0.160 inches thick. A radially outer section 40 of the intermediate portion 18 includes a first turn 40A from the third plane P3 of the center section 32 toward the first plane P1 of the inner portion 16. The outer section 40 passes through the first plane P1 of the inner portion 16 and has a second turn 40B into the second plane P2 of the outer portion 20.

In the illustrated embodiment, the radius R1 of the flywheel 10 (measured from the center to the inside of the ring gear 22) is about 6.098 inches. The radial width W1 of the inner portion 16 is about 1.135 inches, the width W2 of the intermediate portion 18 is about 2.802 inches and the width W3 of the outer portion 20 is about 0.921 inches. Thus, in a preferred embodiment, the planar outer portion 20 of the flywheel 10 occupies about 15% of the total radius of the flywheel, or 19% of the total radial dimension of the flywheel material (i.e., the radius of the flywheel less the radius of the central opening 12). Together, the planar inner and outer portions 16, 20 occupy 34% of the total radius of the flywheel 10 or 42% of the total radial dimension of the flywheel material. The center section 32 of the intermediate portion 18 is also substantially planar and has a width W4 of about 1.948 inches. If this planar extent is included, the total percentage of the flywheel 10 lying in planes perpendicular to the axis AX of the crankshaft CR is about 66% of the total radius of the flywheel 10 or about 82% of the total radial dimension of the flywheel material Stated another way, only about 18% of the total radius of the flywheel material likes outside of a plane perpendicular to the axis AX of the crankshaft CR. Preferably at least about 60% of the surface area of the flywheel material lies in planes perpendicular to the axis AX of the crankshaft CR, more preferably about 75% and most preferably at least about 80%. The absolute dimensions given are exemplary only and may be other than described without departing from the scope of the present invention.

Referring to FIG. 5, a prior art flywheel 110 is shown to have an inner portion 116, an intermediate portion 118, an outer portion 120 and a ring gear 122. The configuration of the inner portion 116 is substantially the same as the configuration of the inner portion 16 of the flywheel 10 of the present invention. The intermediate portion 118 is somewhat similar to the configuration of the intermediate portion 18 of the flywheel 10. However, the intermediate portion 118 does not have arcuate recesses (not show) like the arcuate recesses 38 of the flywheel 10 because the strength cannot be sacrificed in the prior art flywheel 110. Most importantly, radially outer section 140 of the intermediate portion 118 is not formed with first and second turns like the outer section 40 of the present invention. The outer portion 120 of the prior art flywheel 110 likes in a plane P2′ which is skew to both the plane P1′ of the inner portion and the plane P3′ of the intermediate portion, as well as to the axis AX′ of the crankshaft. No part of the outer portion 120 extends in a plane perpendicular to the axis AX′ of the crankshaft. This configuration of the outer portion 120 leads to substantial axial deflection Dₚᵣ of the flywheel 110. Deflection is measured as the movement of the outer edge of the flywheel in a direction parallel to the axis AX of the crankshaft CR from the position of the outer edge when the flywheel is at rest. It has been found that at 8,000 rpm the conventional flywheel 110 deflects to about 0.250 inches, an amount which usually results in bending the flywheel so that it is no longer capable of use. In contrast with the present invention, the deflection D_{new} of the outer edge of the flywheel 10 at 8,000 rpm is about 0.030 to 0.040 inches. At this level of deflection, it is believed that the flywheel 10 will retain its integrity for long periods of time. It will not be necessary to replace the flywheel 10 after every race, reducing the cost of operating the racing vehicle. Moreover, the flywheel 10 is lighter in weight while having a greater resistance to deflection for superior performance.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

What is claimed is:

1. A lightweight, one piece flywheel for a racing vehicle having reduced deflection at high revolution for increasing durability and life, the flywheel being generally circular in shape, the flywheel further comprising an inner portion adapted for mounting the flywheel on a crankshaft of the vehicle, an intermediate portion extending radially outward from the inner portion, an outer portion extending radially outward from the intermediate portion, and gear teeth disposed at the radially outer periphery of the outer portion, the inner portion, outer portion, intermediate portion and gear teeth being formed as one piece, the inner portion lying substantially in a first plane, the outer portion lying substantially in a second plane located to one side of the first plane and substantially parallel to the first plane whereby the flywheel resists deflection at high revolution.

2. A flywheel as set forth in claim 1 wherein the intermediate portion includes a center section lying substantially in a plane parallel to and located on the opposite side of the first plane of the inner portion from the outer portion.

3. A flywheel as set forth in claim 2 wherein the intermediate portion further includes a radially inner section extending from the inner portion of the flywheel to the center section.

4. A flywheel as set forth in claim 3 wherein the intermediate portion further includes a radially outer section extending from the center section of the intermediate portion to the outer portion through the first plane of the inner portion to the second plane of the outer portion, the outer portion extending in the second plane from the radially outer section to the gear teeth.

5. A flywheel as set forth in claim 4 wherein the radially outer section includes a first turn from the center section toward the first plane of the inner portion of the flywheel and a second turn into the second plane of the outer portion.

6. A flywheel as set forth in claim 1 wherein the gear teeth lie substantially in the second plane of the outer portion.

7. A flywheel as set forth in claim 6 wherein the center section of the intermediate portion has a friction material platform facing away from the first plane of the inner portion of the flywheel for use in engaging a clutch of the vehicle.

8. A flywheel as set forth in claim 1 wherein the flywheel has an axis of rotation passing generally through a center of the flywheel, and wherein at least about 60% of the surface area of the flywheel lies in planes perpendicular to the axis of rotation.

9. A flywheel as set forth in claim 8 wherein at least about 75% of the surface area of the flywheel lies in planes perpendicular to the axis of rotation.

10. A flywheel as set forth in claim 9 wherein at least about 80% of the surface area of the flywheel lies in planes perpendicular to the axis of rotation.

11. A flywheel as set forth in claim 1 wherein the outer portion is thinner than the intermediate portion to facilitate reduction in the moment of inertia of the flywheel.

12. A flywheel for a racing vehicle having reduced deflection at high revolution for increasing durability and life, the flywheel being generally circular in shape and having an axis of rotation passing generally through a center of the flywheel, the flywheel further comprising an inner portion adapted for mounting the flywheel on a crankshaft of the vehicle, an intermediate portion extending radially outward from the inner portion, an outer portion extending radially outward from the intermediate portion, and gear teeth disposed at the radially outer periphery of the outer portion, the inner portion, outer portion and intermediate portion being formed as one piece, the inner portion lying substantially in a first plane, the outer portion lying substantially in a second plane, the intermediate portion having a flat center section lying in a third plane, the first, second and third planes being non-coincident with each other, at least about 60% of the surface area of the flywheel lying in planes perpendicular to the axis of rotation whereby the flywheel resists deflection at high revolution.

13. A flywheel as set forth in claim 12 wherein at least about 75% of the surface area of the flywheel lies in planes perpendicular to the axis of rotation.

14. A flywheel as set forth in claim 13 wherein at least about 80% of the surface area of the flywheel lies in planes perpendicular to the axis of rotation.

15. A flywheel as set forth in claim 12 wherein the outer portion is thinner than the intermediate portion to reduce the moment of inertia of the flywheel.

16. A flywheel for a racing vehicle having reduced deflection at high revolution for increasing durability and life, the flywheel being generally circular in shape and having an axis of rotation passing generally through a center of the flywheel, the flywheel further comprising an inner portion adapted for mounting the flywheel on a crankshaft of the vehicle, an intermediate portion extending radially outward from the inner portion, an outer portion extending radially outward from the intermediate portion, and gear teeth disposed at the radially outer periphery of the outer portion, the inner portion, outer portion and intermediate portion being formed as one piece, the inner portion lying substantially in a first plane, the outer portion lying substantially in a second plane, the intermediate portion having a flat center section lying in a third plane, the outer portion being thinner than the intermediate portion to reduce the moment of inertia of the flywheel.

17. A flywheel for a racing vehicle having reduced deflection at high revolution for increasing durability and life, the flywheel being generally circular in shape and having an axis of rotation passing generally through a center of the flywheel, the flywheel further comprising an inner portion adapted for mounting the flywheel on a crankshaft of the vehicle, an intermediate portion extending radially outward from the inner portion, an outer portion extending radially outward from the intermediate portion, and gear teeth disposed at the radially outer periphery of the outer portion, the inner portion, outer portion and intermediate portion being formed as one piece, the inner portion lying substantially in a first plane, the outer portion lying substantially in a second plane, the intermediate portion having a flat center section lying in a third plane, the intermediate portion having a generally channel shape with the flat center section defining the bottom of the channel, whereby the flywheel resists deflection at high revolution.

18. A flywheel as set forth in claim 17 wherein the intermediate portion further includes a radially inner section extending from the inner portion of the flywheel to the center section, and a radially outer section extending from the center section of the intermediate portion to the outer portion through the first plane of the inner portion to the second plane of the outer portion, the outer portion extending in the second plane from the radially outer section to the gear teeth.

19. A flywheel as set forth in claim 18 wherein the radially outer section includes a first turn from the center section toward the first plane of the inner portion of the flywheel and a second turn into the second plane of the outer portion.
